(19) United States
(12) Patent Application Publication
(10) Pub. No.: US 2010/0093481 A1
(43) Pub. Date: Apr. 15, 2010

(54) LOCKING DIFFERENTIAL HAVING IMPROVED CLUTCH TEETH

(75) Inventor: Randal A. Lyman, Everett, WA (US)

Correspondence Address: BLACK LOWE & GRAHAM, PLLC, 701 FIFTH AVENUE, SUITE 4800, SEATTLE, WA, 98104, US

(73) Assignee: Randy's Ring & Pinion, Everett, WA (US)

(21) Appl. No.: 12/249,609

(22) Filed: Oct. 10, 2008

(51) Int. Cl. F16H 48/30

(52) U.S. Cl. 475/231

(57) ABSTRACT

A hold-out ring type locking differential for an automobile or other type of motorized vehicle includes a differential case housing a number of components, such as a center driver positioned between holdout rings, clutch members, springs, spring retainers, side gears, and thrust washers. The center driver includes a center cam that engages inner teeth of the clutch members, which in turn include a tooth shape or profile for reducing stress and wear while increasing an operational life of the clutch member. The inner clutch teeth each have a top portion coupled to a base portion at an intersection point. The top portion extends from the intersection point to a free edge surface while the base portion extending from the intersection point continually into a root radius region.

### FIELD OF THE INVENTION

This invention relates generally to a locking differential system of a hold-out-ring type having clutch members selectively engageable with a center driving member.

### BACKGROUND OF THE INVENTION

Differentials for automotive-type applications are used in many front or rear axles to transmit the power from the engine to the driven wheels of the vehicle. Conventional differentials permit a vehicle to turn corners with one wheel rolling faster than the other and generally include two side gears coupled to the output or driven shafts, which in turn are coupled to the respective left and right wheels of the vehicle. The differential case generally includes a ring gear driven by a pinion gear coupled to an end of the vehicle drive shaft driven by the engine. Side gears are located within and coupled to the differential case while typically being splined or otherwise coupled to the respective driven shafts. The side gears may be controlled by various means to permit the driven shafts to power both wheels during most vehicle maneuvers. But when turning, this arrangement of the differential permits the outer wheel to overrun (i.e., rotate faster than) the inner wheel, which lags (i.e., rotates slower). The amount of overrun rate is generally equivalent to the amount of lag.

There are a variety of differential types such as conventional or “open” differentials, limited slip differentials, and lockable or locking differentials. These types are distinguishable by how they handle various possible operating conditions.

Locking differentials contain mechanisms and features which cause the differential to prevent or limit rotational speed differences between the left and right driven wheels. Different methodologies are used to actuate these mechanisms. The most common means for actuation of the mechanism in a locking differential are pneumatic, hydraulic, electric, electromechanical, mechanical friction or some combination thereof.

In addition, at least some of these differentials may be characterized as hold-out ring type differentials in which a center driving member engages a pair of clutch members. The center driving member and the clutch members each have corresponding sets of engagement teeth, for example an inner set of clutch cam teeth and an outer set of engagement teeth. Spring devices may be or may not be employed to outwardly bias side gears in an axial direction within the differential. One type of hold-out ring type differential is described in U.S. Pat. No. 6.076,429 to Valente, which teaches that at least one set of the clutch cam teeth are trapezoidally configured to reduce stress in the teeth. As shown in FIGS. 1A and 1B, the '429 patent further teaches a clutch member 10 includes trapezoidally configured inner clutch cam teeth 12 that are complementarily formed with respect to corresponding teeth on a center cam driving member (not shown). Accordingly, the '429 patent teaches there is little or no space between the teeth 12 and the teeth of the center cam member (not shown) when engaged. As discussed in the '429 patent, the trapezoidally-shaped inner teeth 12 of the clutch member 10 are intended to be an improvement over conventional clutch teeth, which are illustrated in FIG. 1C on clutch member 14 as dove-tail shaped teeth 16. Some other conventional differentials of the hold-out ring type are described in U.S. Pat. No. 3,791,238 (Bokovoy); U.S. Pat. No. 4,424,725 (Bawks); U.S. Pat. No. 4,557,158 (Dissett et al.); U.S. Pat. No. 4,745,818 (Edwards et al.); and U.S. Pat. No. 5,524,509 (Dissett).

### SUMMARY OF THE INVENTION

The present invention is generally related to a locking differential of the hold-out ring type having a center driving member that includes a center cam and where the center driving member engages a pair of clutch members. Each of the clutch members may have an inner set of clutch cam teeth and an outer set of engagement teeth. During an overrun condition, the inner set of clutch cam teeth cooperate with corresponding teeth on the center cam to disengage the clutch member from the center driving member. In one embodiment, the inner set of clutch cam teeth of the clutch members are configured such that top portions of the teeth are couple to filleted base regions or root radius regions through intersection points.

In one example, a differential system for disengaging an overrunning output shaft from a center driving member includes a differential case having a cavity for receiving the center driving member, the center driving member having a center cam. An annular clutch member is located within the cavity and arranged for engagement with the center driving member. The clutch member includes a plurality of outer clutch engagement teeth extending from a first surface and configured to engage corresponding teeth on the center driving member of the differential. The clutch member further includes a plurality of inner clutch cam teeth extending from a second surface and operable to disengage the outer clutch engagement teeth from the center driving member. The inner clutch cam teeth each have a top portion coupled to a base portion at an intersection point. The top portion extends from the intersection point to a free edge surface. The base portion extends from the intersection point continually into a root radius region that further transitions into the second surface.

In another example, a clutch member for a differential system includes a plurality of outer clutch engagement teeth extending from a first surface and configured to engage corresponding teeth on a center driving member of the differential system. The clutch member further includes a plurality of inner clutch cam teeth extending from a second surface and operable to disengage the outer clutch engagement teeth from the center driving member. The inner clutch cam teeth each have a top portion coupled to a base portion at an intersection point. The top portion extends from the intersection point to a free edge surface. The base portion extends from the intersection point continually into a root radius region that further transitions into the second surface.

### BRIEF DESCRIPTION OF THE DRAWINGS

The sizes and relative positions of elements in the drawings or images may not necessarily be to scale. For example, some elements may be arbitrarily enlarged or otherwise modified to improve clarity. Further, the illustrated shapes of the elements may not convey their actual shapes, and have been solely selected for ease of recognition. Various embodiments are briefly described with reference to the following drawings:

FIG. 1A is a side elevational view of a prior-art clutch member;

FIG. 1B is a cross-sectional view of the prior-art clutch member of FIG. 1A taken along line 1B-1B of FIG. 1A having trapezoidally-shaped clutch teeth;

FIG. 1C is a cross-sectional view of a prior-art clutch member having dove-tail shaped clutch teeth;

FIG. 2 is an isometric exploded view of a differential system having clutch members engageable with a center driving member according to one illustrated embodiment of the invention;

FIG. 3 is an isometric view of one of the clutch members of FIG. 2 according to an illustrated embodiment of the invention;

FIG. 4 is a side elevational view of the clutch member of FIG. 3;

FIG. 5 is a cross-sectional view of the clutch member of FIG. 4 taken along line 5-5 of FIG. 4; and

FIG. 6 is a close-up view of an inner tooth of the clutch member of FIG. 4.

### DETAILED DESCRIPTION OF THE INVENTION

In the following description, certain specific details are set forth in order to provide a thorough understanding of various embodiments of the invention. However, the invention may be practiced without these details or with various combinations of these details. In other instances, well-known structures and methods associated with differential systems, driving and output mechanisms for the differential systems, and sub-assemblies located within a housing or case of the differential system, and methods of assembling, operating and using the same may not be shown or described in detail to avoid unnecessarily obscuring descriptions of the embodiments of the invention.

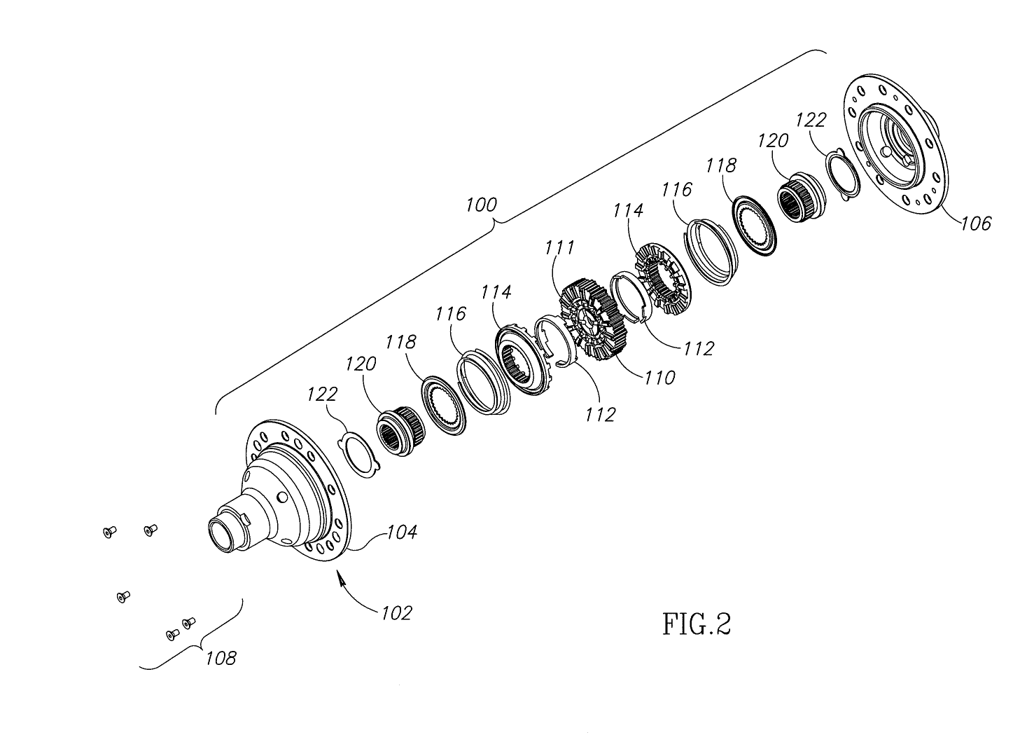

FIG. 2 shows an embodiment of the present invention that takes the form of a hold-out ring type locking differential 100 for an automobile or other type of motorized vehicle. The hold-out ring type locking differential 100 includes a differential case 102 having a first case half 104 coupled to a second case half 106 with fasteners 108 or some other type of mechanical connection for connecting the two halves 104, 106. Within the case 102, the differential 100 includes a center driver 110 positioned between holdout rings 112, clutch members 114, springs 116, spring retainers 118, side gears 120, and thrust washers 122. The center driver 110 includes a center cam 111 that engages inner teeth of the clutch members 114. These aforementioned components, except for the clutch members 114, may be substantially similar or even identical to like components found in a conventional, hold-out ring type differential. The clutch members 114, and in particular the inner teeth thereof, shall now be described in more detail below.

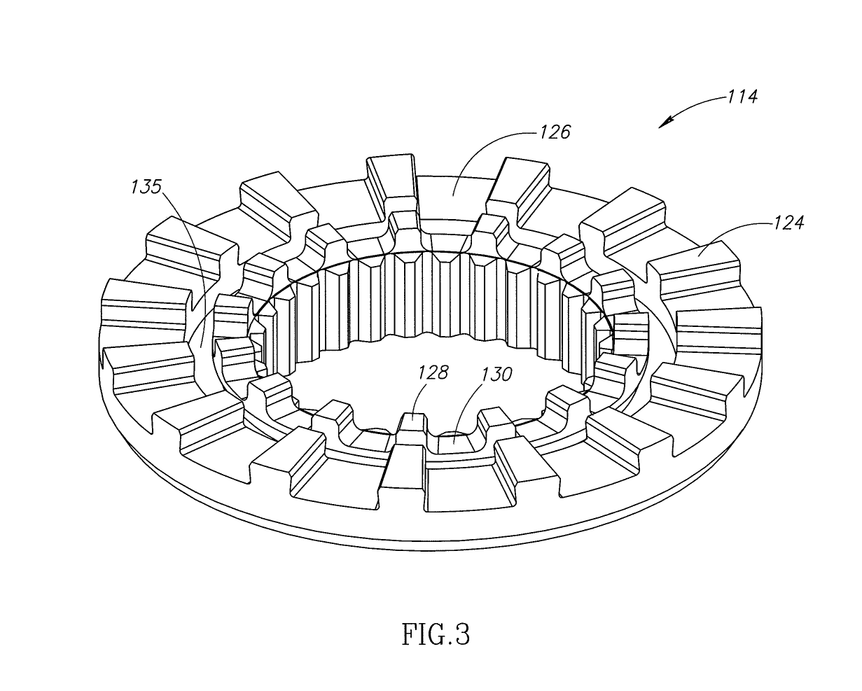

FIGS. 3, 4 and 5 shows one of the clutch members 114 having a plurality of outer clutch engagement teeth 124 extending from a first surface 126 and configured to engage corresponding teeth on the center driving member 110 (FIG. 2) of the differential system 100 (FIG. 2). The clutch member 114 further includes a plurality of inner clutch cam teeth 128 extending from a second surface 130 (FIG. 5) and operable to disengage the outer clutch teeth 124 from the center driving member 110. The inner clutch cam teeth 128 each include a top portion 132 coupled to a base portion 134. A groove 135 is located between the outer clutch engagement teeth 124 and the inner clutch cam teeth 128 and is configured to receive the holdout ring 112.

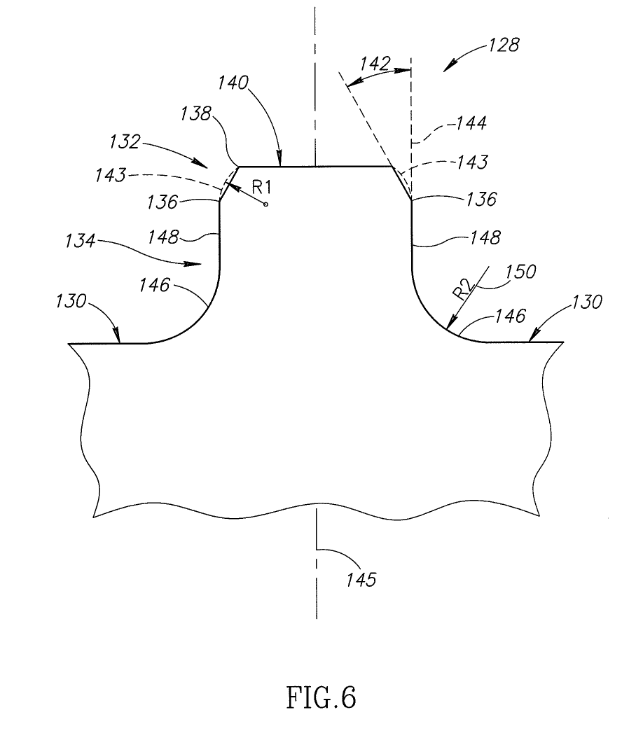

As best seen in FIG. 6, the top portion 132 of the tooth 128 extends from a first intersection point 136 toward a second intersection point 138 adjacent an end surface 140 of the tooth 128. With respect to the first and second intersection points 136, 138, the top portion 132 may be positioned at an angle 142. The angle 142, as measured from a hypothetical vertical line 144, may be any angle that is more or less parallel to the corresponding surfaces of the mating center cam 111 teeth. Also, instead of an angle 142, a radius 143 may start at the intersection 138 while extending tangentially from the surface 140, and then continue into the intersection 136 and end up tangent to the surface 148.

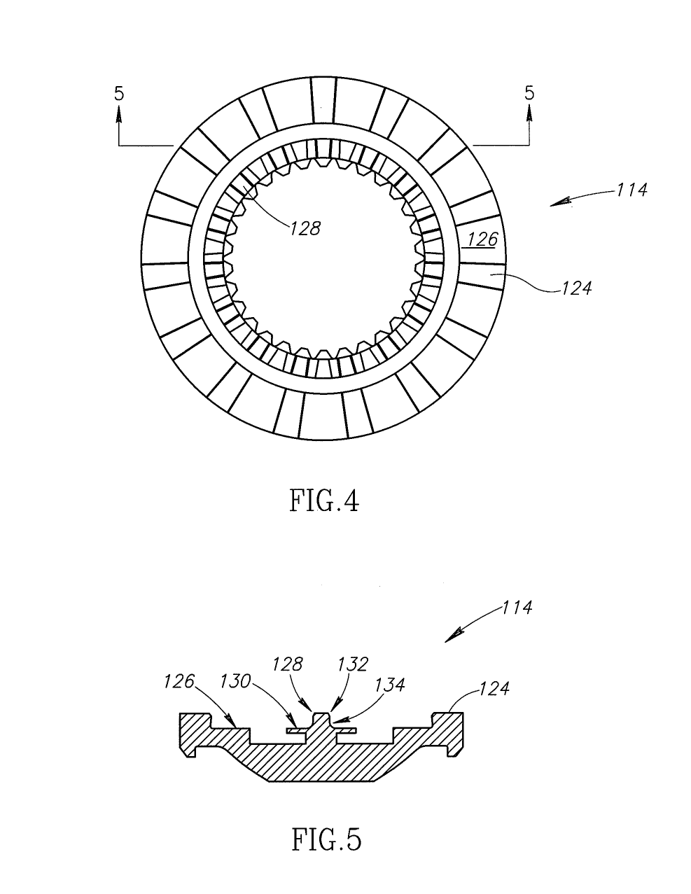

The base portion 134 extends from the first intersection point 136 into a fillet or root radius region 146, which in turn continually transitions into the second surface 130 (FIG. 4). In one embodiment, an upper portion 148 of the base portion 134 may be substantially straight relative to the vertical line 144 as it transitions into the root radius region 146. By way of example, the vertical line 144 may be substantially parallel to a longitudinal line 145 that corresponds to a length of the tooth 128. In another embodiment, the upper portion 148 gradually curves into the root radius region 146. A radius “R2” as indicated by line 150 of the root radius region 146 may be any suitable value within a range of about 0.5 mm to 2.5 mm; and preferably about 1.5 mm.

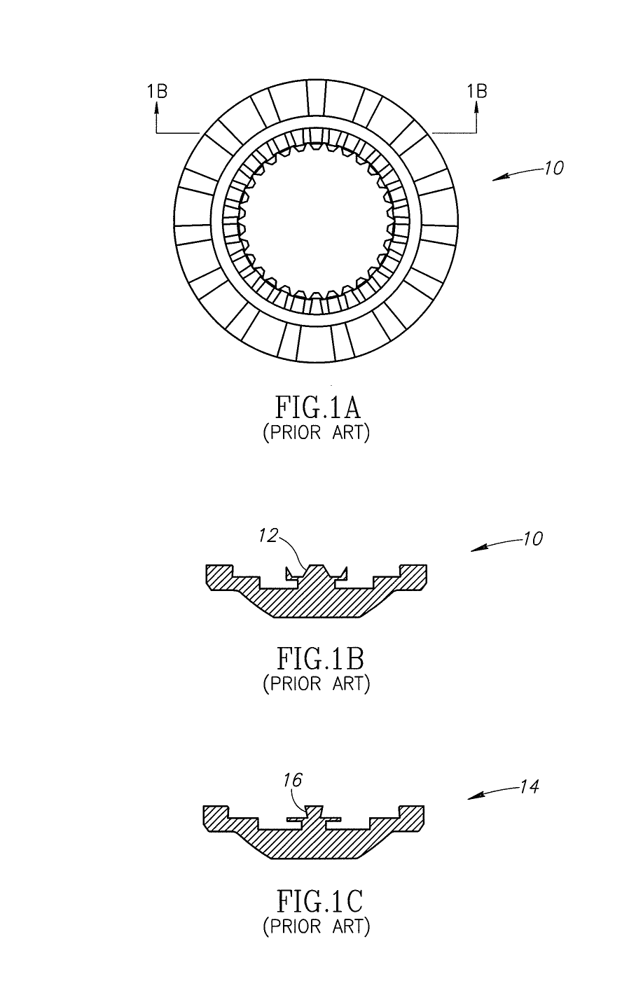

The shape of the inner clutch teeth 128 includes straight, but optionally angled or radiused top portions 132 and a more or less large root radius region 146. Such a configuration may advantageously reduce the stress caused by applied load and other loads compared to the conventional tooth configuration shown in FIG. 1C, this is similar to or better than the strength advantage offered by the trapezoidal tooth configuration shown in FIG. 1B. Likewise, the reduction in stress over an operational life of the clutch member 114 may substantially extend the life of the clutch member, thus reducing repair, maintenance and/or replacement costs. Another possible advantage of the tooth shape of the inner clutch member teeth 128 is that the large root radius region 146 permits better management of a hardened case thickness applied to the teeth 128 during heat treatment after machining of the teeth 128. Further, the tooth shape offers a reduction in friction between the center cam 111 and the inner teeth 128 of the clutch members 114 at least in part because the tooth shape may advantageously decrease a surface contact area as compared to the tooth shapes shown in FIG. 1B. As such, the shape of the teeth 128 permits the clutch members 114 to start ramping up the center cam 111 with a lower amount of applied torque while generating little to no increase in wear or fatigue damage.

Many other changes can be made in light of the above detailed description. In general, in the following claims, the terms used should not be construed to limit the invention to the specific embodiments disclosed in the specification and the claims, but should be construed to include all types of differentials, gears, gear systems, actuation systems, differential cases, preloaded thrust assemblies and methods of assembling the same that operate in accordance with the claims. Accordingly, the invention is not limited by the disclosure, but instead its scope is to be determined entirely by the following claims.

What is claimed is:

1. A differential system for disengaging an overrunning output shaft from a center driving member, the differential system comprising:
a differential case having a cavity for receiving the center driving member, the center driving member having a center cam;
an annular clutch member located within the cavity and arranged for engagement with the center driving member, the clutch member having a plurality of outer clutch teeth extending from a first surface and configured to engage corresponding teeth on the center driving member of the differential, the clutch member further having a plurality of inner clutch teeth extending from a second surface and operable to disengage the outer clutch teeth from the center driving member, the inner clutch teeth each having a top portion coupled to a base portion at an intersection point, the top portion extending from the intersection point to a free edge surface, the base portion extending from the intersection point continually into a root radius region that further transitions into the second surface.

2. The differential system of claim 1, wherein the base portion is configured to reduce an amount of stress caused by operational loads within the differential system.

3. The differential system of claim 1, wherein the top portion extends at an angle relative to a vertical line that is substantially parallel to a longitudinal length of the inner clutch teeth.

4. The differential system of claim 1, wherein the top portion includes a radius extending tangentially from the free edge surface to the intersection point.

5. The differential system of claim 1, wherein the intersection point is located at approximately half way between the free edge and the second surface.

6. The differential system of claim 1, wherein the center cam includes teeth configured to complimentarily engage the inner teeth of the clutch member.

7. A clutch member for a differential system, the clutch member comprising:
a plurality of outer clutch teeth extending from a first surface and configured to engage corresponding teeth on a center driving member of the differential system; and
a plurality of inner clutch teeth extending from a second surface and operable to disengage the outer clutch teeth from the center driving member, the inner clutch teeth each having a top portion coupled to a base portion at an intersection point, the top portion extending from the intersection point to a free edge surface, the base portion extending from the intersection point continually into a root radius region that further transitions into the second surface.

8. The clutch member of claim 7, wherein the base portion is configured to reduce an amount of stress caused by operational loads within the differential system.

9. The clutch member of claim 7, wherein the top portion extends at an angle relative to a vertical line that is substantially parallel to a longitudinal length of the inner clutch teeth.

10. The clutch member of claim 7, wherein the top portion includes a radius extending tangentially from the free edge surface to the intersection point.
